(19) United States
(12) Patent Application Publication
(10) Pub. No.: US 2016/0069503 A1
(43) Pub. Date: Mar. 10, 2016

(54) Process for lining metal pipelines

(71) Applicant: SOLVAY SPECIALTY POLYMERS ITALY S.P.A., Bollate (MILANO) (IT)

(72) Inventors: Nicasio Edoardo MESSINA, Zerbolo (PV) (IT); Eric MARTIN, Hannut (BE); Mohammad Jamal EL-HIBRI, Atlanta, GA (US)

(73) Assignee: SOLVAY SPECIALTY POLYMERS ITALY S.P.A., BOLLATE, MI (IT)

(21) Appl. No.: 14/787,892

(22) PCT Filed: Apr. 16, 2014
(86) PCT No.: PCT/EP2014/057820

§ 371 Date: Oct. 29, 2015

Related U.S. Application Data
(60) Provisional application No. 61/816,897, filed on Apr. 29, 2013.

(30) Foreign Application Priority Data
Sep. 10, 2013 (EP) 13183751.0

(51) Int. Cl. F16L 58/10; B29C 65/00; F16L 9/147; B29C 65/70

(52) U.S. Cl. CPC F16L 58/1036; B29C 65/70; B29C 66/612; B29C 66/742; F16L 9/147; B29K 2071/00

(57) ABSTRACT

The present invention pertains to a process for lining a metal pipeline, said process comprising the following steps: (i) processing a thermoplastic polymer composition thereby providing a pipe liner having an outer diameter greater than the inner diameter of said metal pipeline, said thermoplastic polymer composition comprising, preferably consisting of:—at least one poly(aryl ether ketone) polymer [(PAEK) polymer],—at least one poly(phenylene sulfone) polymer [(PPSU) polymer],—optionally, at least one poly(arylene sulfide) [(PAS) polymer], and—optionally, at least one plasticizer; (ii) deforming said pipe liner thereby providing a deformed pipe liner having an outer diameter smaller than the inner diameter of said metal pipeline; (iii) inserting the deformed pipe liner in said metal pipeline; and (iv) expanding the deformed pipe liner to fit with the inner diameter of said metal pipeline. The present invention also relates to a pipeline system comprising at least two coaxial pipes, an outer metal pipeline and inner pipe comprising at least one layer comprising, preferably made of said thermoplastic polymer composition.

### PROCESS FOR LINING METAL PIPELINES

This application claims priority to U.S. provisional application No. 61/816,897 filed on Apr. 29, 2013 and to European application No. 13183751.0 filed on Sep. 10, 2013, the whole content of these applications being incorporated herein by reference for all purposes.

### TECHNICAL FIELD

The present invention pertains to a process for lining a metal pipeline using a thermoplastic polymer pipe liner and to a pipeline system comprising at least two coaxial pipes, an outer metal pipe and an inner thermoplastic polymer pipe.

### BACKGROUND ART

Pipelines suitable for use in downhole applications, in particular off-shore pipelines, such as those used to pump oil and gas ashore from off-shore drilling rigs and terminals, are required to be capable of withstanding very high internal pressures and temperatures and are therefore typically made of metals such as iron and steel.

Corrosion of the metal pipelines represents one of the major issues encountered during downhole operations under extreme temperature and pressure conditions.

In order to protect the inner bore of the pipeline from the corrosive effects of materials passing through them, such as mixtures of hydrocarbons, water and other contaminants, e.g. carbon dioxide and hydrogen sulfide, it has been already proposed to insert a tubular liner made of a suitable polymeric material into the metal pipeline.

In order to be able to install a liner in an existing metal pipeline, the liner either needs to be considerably under-sized with respect to the pipeline, in which case the long term stability and integrity of the liner would be compromised, or the liner needs to be capable of being installed in a contracted form and then expanded to full or nearly full size to fit with the pipeline.

High density polyethylene has long been used for liners in land-based pipelines carrying mains water. However, polyethylene is not suitable for use in harsh chemical environments.

Poly(ether ether ketone) (PEEK) has also been proposed as suitable material for the manufacture of liners for downhole applications on account of its outstanding tensile strength as well as outstanding long-term creep and aging properties up to temperatures approaching its melting point of about 340° C. In addition, PEEK is highly chemical resistant to well fluids, drilling fluids and hydrocarbon mixtures while providing low permeability to gases such as carbon dioxide and hydrogen sulfide.

For instance, WO 2004/016419 (ROBROY INDUSTRIES INC.) 26.02.2004 discloses liners made from an extrudable resin composition comprising a high temperature thermoplastic polymer and use thereof for lining metal tubulars in downhole applications. The diameter of the liner is smaller than the diameter of the tubular in which it is inserted thereby creating a space or annular gap between the liner and the tubular. Suitable high temperature thermoplastic polymers include, but are not limited to, poly(aryl ketones) such as poly(ether ether ketone) (PEEK), poly(ether ketone) (PEK) and poly(ether ketone ketone) (PEKK), poly(phenylene sulfide) (PPS), poly(phenylene sulfone) (PPSU), poly(ether sulfone) (PES) and polyolefins such as homopolymers and copolymers of propylene and ethylene.

Further, EP 1945439 A (VICTREX MANUFACTURING LIMITED) 23.07.2008 discloses a method of fitting a compressed component within a receiver, wherein the compressed component comprises a polymeric material comprising a first polymer having a glass transition temperature (Tg) of at least 100° C. and, optionally, a second polymer. The first polymer may be a poly(ether ether ketone) having a Tg of 143° C. and the second polymer may be a poly(ether sulphone) having a Tg of about 220° C. The compressed component may be a pipe having a substantially circular internal cross-section.

There is thus still a need in the art for a solid-wall pipe liner endowed with suitable mechanical properties to be successfully installed in oil and gas metal pipelines in a contracted form and then expanded to its full or nearly full size to fit with the pipeline, without cracking or fracturing of the pipe, while being resistant to heat and pressure and to harsh chemical environments in the long term.

### SUMMARY OF INVENTION

It is thus an object of the present invention a process for lining a metal pipeline, said process comprising the following steps:

(i) processing a thermoplastic polymer composition thereby providing a pipe liner having an outer diameter greater than the inner diameter of said metal pipeline, said thermoplastic polymer composition comprising, preferably consisting of:
at least one poly(aryl ether ketone) polymer [(PAEK) polymer],
at least one poly(phenylene sulfone) polymer [(PPSU) polymer],
optionally, at least one poly(arylene sulfide) polymer [(PAS) polymer], and
optionally, at least one plasticizer;

(ii) deforming said pipe liner thereby providing a deformed pipe liner having an outer diameter smaller than the inner diameter of said metal pipeline;

(iii) inserting the deformed pipe liner in said metal pipeline; and

(iv) expanding the deformed pipe liner to fit with the inner diameter of said metal pipeline.

It has been surprisingly found that the pipe liner made of the thermoplastic polymer composition of the process of the invention is a solid-wall pipe endowed with a combination of mechanical properties that make it suitable for successfully lining metal pipelines, commonly operating at high temperatures and pressures, while also protecting said metal pipelines from corrosive effects of harsh materials passing through them.

In particular, it has been found that the pipe liner of the process of the invention is advantageously endowed with lower flexural modulus and higher tensile elongation at yield to be successfully used in the process of the invention.

Flexural modulus is a measure of the tendency of the pipe liner to deform under the influence of an applied stress.

Tensile elongation at yield is a measure of the maximum stress to be applied at which the pipe liner yields.

The flexural modulus and the tensile elongation at yield are thus a measure of flexibility of the thermoplastic polymer composition forming the pipe liner under the influence of pressure impacts, in particular at high operating temperatures.

Under step (ii) of the process of the invention, the pipe liner is advantageously elastically deformed.

By the term “elastic deformation” it is hereby intended to denote temporary and reversible deformation of the thermoplastic polymer composition forming the pipe liner.

Should the stress applied to the pipe liner under step (ii) of the process of the invention be lower than the yield strength of said thermoplastic polymer composition, the deformed pipe liner can be advantageously expanded under step (iii) of said process by recovery of its elastic deformation.

The yield strength is a measure of the maximum stress to be applied at which the pipe liner begins to deform plastically. The stress at which yield occurs is dependent on both the rate of deformation (strain rate) and, more significantly, on the temperature at which the deformation occurs.

By the term “plastic deformation” it is hereby intended to denote permanent and non-reversible deformation of the thermoplastic polymer composition forming the pipe liner.

Also, it has been found that the pipe liner of the process of the invention is advantageously endowed with higher heat deflection temperature to be successfully used in the process of the invention.

The heat deflection temperature is a measure of the temperature at which the pipe liner begins to deform plastically under a specified load.

The heat deflection temperature is thus a measure of thermo-mechanical resistance of the thermoplastic polymer composition forming the pipe liner under the influence of pressure impacts, in particular at high operating temperatures.

By the term “pipe liner”, it is hereby intended to denote a continuous tubular pipe made of the thermoplastic polymer composition as defined above or a continuous tubular pipe whose inner surface is coated with a layer made of the thermoplastic polymer composition as defined above.

The pipe liner of the process of the invention may be a monolayer pipe or a multilayer pipe.

By the term “monolayer”, it is hereby intended to denote a pipe liner consisting of one tubular layer made of the thermoplastic polymer composition as defined above.

By the term “multilayer”, it is hereby intended to denote a pipe liner comprising at least two concentric layers adjacent to each other, wherein at least the inner layer is made of the thermoplastic polymer composition as defined above.

The metal pipeline of the process of the invention is usually an iron or steel pipeline, preferably a steel pipeline, more preferably a carbon, alloy or stainless steel pipeline.

The pipe liner of the process of the invention is particularly suitable for lining metal pipelines conveying hydrocarbons at temperatures of up to 130° C. or more, such as on-shore and off-shore metal pipelines, preferably off-shore oil and gas metal pipelines.

According to an embodiment of the process of the invention, the metal pipeline may be an existing damaged metal pipeline. Should the metal pipeline be an existing damaged metal pipeline, the lining process of the invention is a lining rehabilitation process.

For the purpose of the present invention, the term “thermoplastic” is understood to mean a polymer composition existing, at room temperature, below its glass transition temperature, if it is amorphous, or below its melting point if it is semi-crystalline, and which is linear (i.e. not reticulated). This polymer composition has the property of becoming soft when it is heated and of becoming rigid again when it is cooled, without there being an appreciable chemical change. Such a definition may be found, for example, in the encyclopedia called “Polymer Science Dictionary”, Mark S. M. Alger, London School of Polymer Technology, Polytechnic of North London, UK, published by Elsevier Applied Science, 1989.

Within the context of the present invention, the term “at least one poly(aryl ether ketone) polymer [(PAEK) polymer]” is intended to denote one or more than one (PAEK) polymers. Mixtures of (PAEK) polymers can be advantageously used for the purpose of the invention.

In the rest of the text, the expressions “(PAEK) polymer” are understood both in the plural and in the singular, that is to say that the thermoplastic polymer composition may comprise one or more than one (PAEK) polymers.

For the purpose of the invention, the term “poly(aryl ether ketone) polymer [(PAEK) polymer]” is intended to denote any polymer comprising recurring units wherein more than 50% by moles of said recurring units are recurring units (R_{PAEK}) comprising a Ar—C(O)—Ar′ group, wherein Ar and Ar′, equal to or different from each other, are aromatic moieties comprising at least one aromatic mono- or poly-nuclear cycle. The recurring units (R_{PAEK}) are generally selected from the group consisting of those of formulae (J-A) to (J-O) here below:

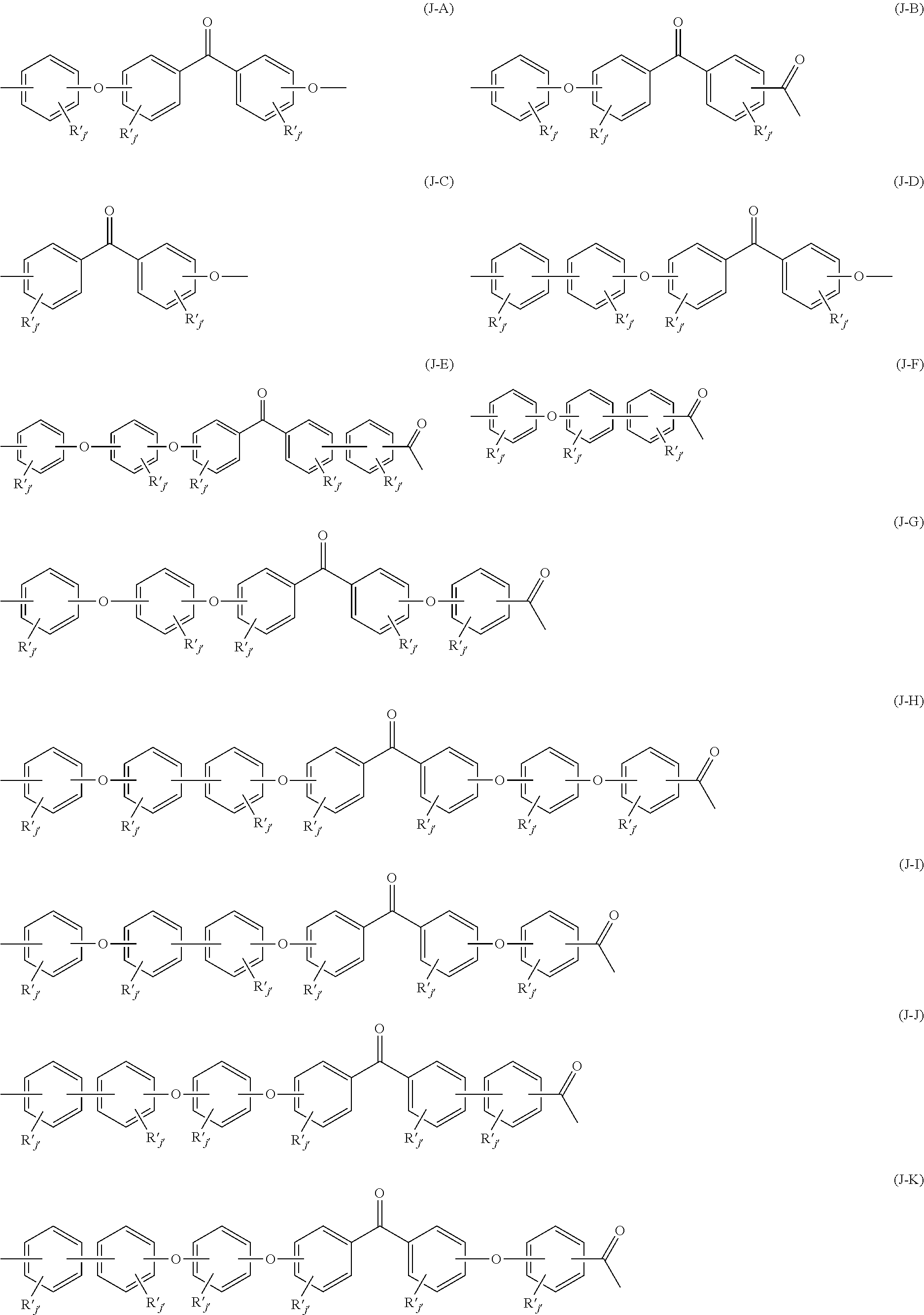

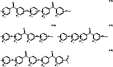

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or an integer from 1 to 4.

In recurring units (R_{PAEK}), the respective phenylene moieties may independently have 1,2-, 1,4- or 1,3-linkages to the other moieties different from R′ in the recurring units. Preferably, said phenylene moieties have 1,3- or 1,4-linkages, more preferably they have 1,4-linkage.

Still, in recurring units (R_{PAEK}), j′ can be at each occurrence zero, that is to say that the phenylene moieties have no other substituents than those enabling linkage in the main chain of the (PAEK) polymer.

Preferred recurring units (R_{PAEK}) are thus selected from the group consisting of those of formulae (J′-A) to (J′-O) here below:

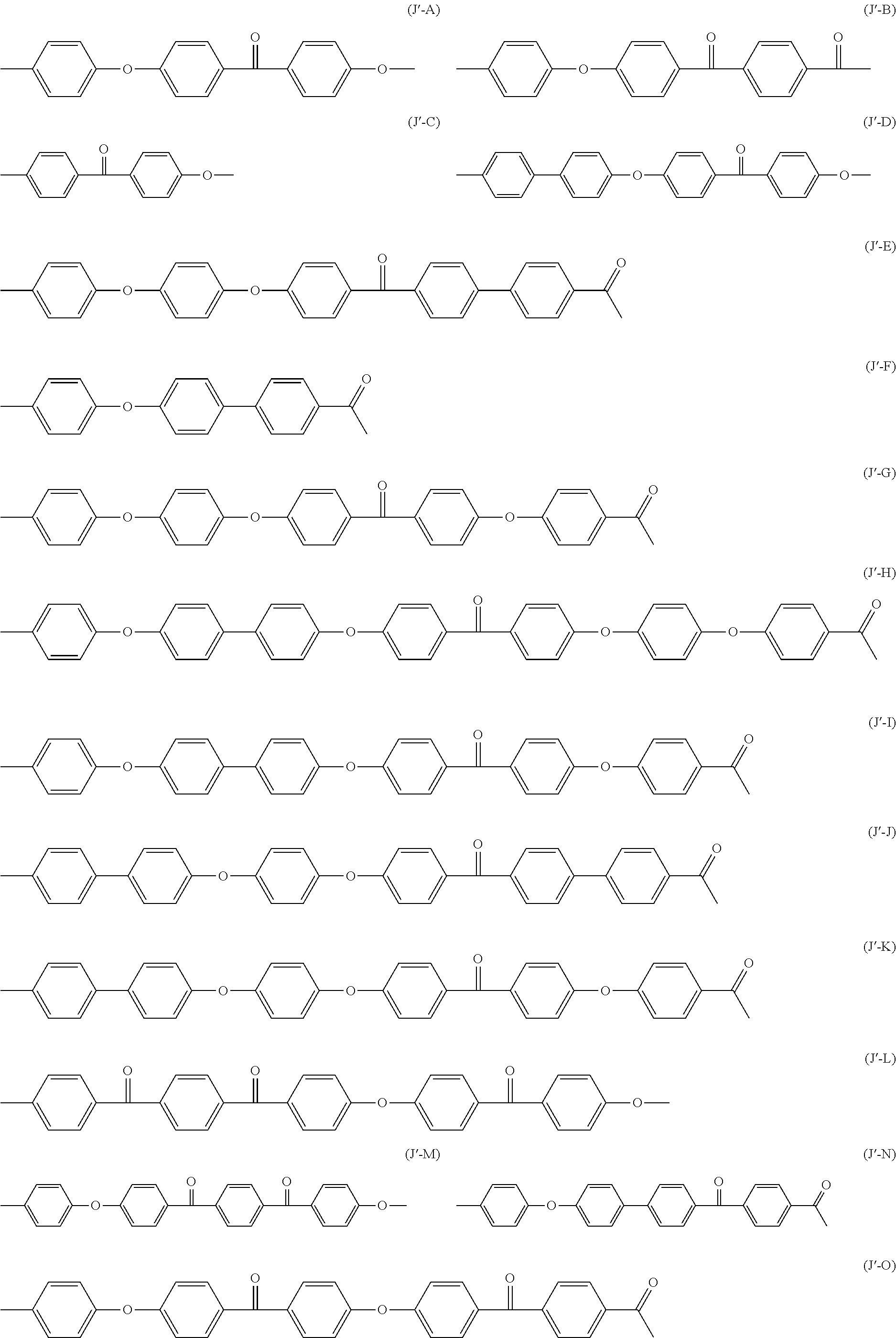

In the (PAEK) polymer, as defined above, preferably more than 60% by moles, more preferably more than 80% by moles, even more preferably more than 90% by moles of the recurring units are recurring units (R_{PAEK}) as defined above.

Still, it is generally preferred that substantially all recurring units of the (PAEK) polymer are recurring units (R_{PAEK}) as defined above; chain defects or minor amounts of other recurring units might be present, being understood that these latter do not substantially modify the properties of recurring units (R_{PAEK}).

The (PAEK) polymer may be notably a homopolymer or a copolymer such as a random, alternate or block copolymer. When the (PAEK) polymer is a copolymer, it may notably contain (i) recurring units (R_{PAEK}) of at least two different formulae chosen from formulae (J-A) to (J-O), or (ii) recurring units (R_{PAEK}) of one or more formulae (J-A) to (J-O) and recurring units (R*_{PAEK}) different from recurring units (R_{PAEK}).

As will be detailed later on, the (PAEK) polymer may be a poly(ether ether ketone) polymer [(PEEK) polymer]. Alternatively, the (PAEK) polymer may be a poly(ether ketone ketone) polymer [(PEKK) polymer], a poly(ether ketone) polymer [(PEK) polymer], a poly(ether ether ketone ketone) polymer [(PEEKK) polymer], or a poly(ether ketone ether ketone ketone) polymer [(PEKEKK) polymer].

The (PAEK) polymer may also be a blend composed of at least two different (PAEK) polymers chosen from the group consisting of (PEKK) polymers, (PEEK) polymers, (PEK) polymers and (PEKEKK) polymers, as defined above.

For the purpose of the present invention, the term “(PEEK) polymer” is intended to denote any polymer comprising recurring units wherein more than 50% by moles of said recurring units are recurring units (R_{PAEK}) of formula J′-A.

Preferably more than 75% by moles, more preferably more than 85% by moles, even more preferably more than 95% by moles, still more preferably more than 99% by moles of the recurring units of the (PEEK) polymer are recurring units (R_{PAEK}) of formula J′-A. Most preferably all the recurring units of the (PEEK) polymer are recurring units (R_{PAEK}) of formula J′-A.

For the purpose of the present invention, the term “(PEKK) polymer” is intended to denote any polymer comprising recurring units wherein more than 50% by moles of said recurring units are recurring units (R_{PAEK}) of formula J′-B.

Preferably more than 75% by moles, more preferably more than 85% by moles, even more preferably more than 95% by moles, still more preferably more than 99% by moles of the recurring units of the (PEKK) polymer are recurring units (R_{PAEK}) of formula J′-B. Most preferably all the recurring units of the (PEKK) polymer are recurring units (R_{PAEK}) of formula J′-B.

For the purpose of the present invention, the term “(PEK) polymer” is intended to denote any polymer comprising recurring units wherein more than 50% by moles of said recurring units are recurring units (R_{PAEK}) of formula J′-C.

Preferably more than 75% by moles, more preferably more than 85% by moles, even more preferably more than 95% by moles, still more preferably more than 99% by moles of the recurring units of the (PEK) polymer are recurring units (R_{PAEK}) of formula J′-C. Most preferably all the recurring units of the (PEK) polymer are recurring units (R_{PAEK}) of formula J′-C.

For the purpose of the present invention, the term “(PEEKK) polymer” is intended to denote any polymer comprising recurring units wherein more than 50% by moles of said recurring units are recurring units (R_{PAEK}) of formula J′-M.

Preferably more than 75% by moles, more preferably more than 85% by moles, even more preferably more than 95% by moles, still more preferably more than 99% by moles of the recurring units of the (PEEKK) polymer are recurring units (R_{PAEK}) of formula J′-M. Most preferably all the recurring units of the (PEEKK) polymer are recurring units (R_{PAEK}) of formula J′-M.

For the purpose of the present invention, the term “(PEKEKK) polymer” is intended to denote any polymer comprising recurring units wherein more than 50% by moles of said recurring units are recurring units (R_{PAEK}) of formula J′-L.

Preferably more than 75% by moles, more preferably more than 85% by moles, even more preferably more than 95% by moles, still more preferably more than 99% by moles of the recurring units of the (PEKEKK) polymer are recurring units (R_{PAEK}) of formula J′-L. Most preferably all the recurring units of the (PEKEKK) polymer are recurring units (R_{PAEK}) of formula J′-L.

Excellent results were obtained when the (PAEK) polymer was a (PEEK) homopolymer, i.e. a polymer of which substantially all the recurring units of the (PEEK) polymer are recurring units (R_{PAEK}) of formula J′-A, wherein chain defects or minor amounts of other recurring units might be present, being understood that these latter do not substantially modify the properties of the (PEEK) homopolymer.

Non limitative examples of (PAEK) polymers suitable for the invention include those commercially available under the trademark name KETASPIRE® PEEK from Solvay Specialty Polymers USA L.L.C.

Within the context of the present invention, the term “at least one poly(phenylene sulfone) polymer [(PPSU) polymer]” is intended to denote one or more than one (PPSU) polymers. Mixtures of (PPSU) polymers can be advantageously used for the purpose of the invention.

In the rest of the text, the expressions “(PPSU) polymer” are understood both in the plural and in the singular, that is to say that the inventive composition may comprise one or more than one (PPSU) polymers.

For the purpose of the invention, the term “poly(phenylene sulfone) polymer [(PPSU) polymer]” is intended to denote any polymer comprising recurring units wherein more than 50% by moles of the recurring units of said (PPSU) polymer are recurring units (R_{PPSU}) of formula (K-A):

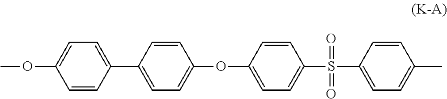

In a preferred embodiment of the present invention, more than 75% by moles, preferably more than 90% by moles, more preferably more than 99% by moles, even more preferably substantially all the recurring units of the (PPSU) polymer are recurring units (R_{PPSU}) of formula (K-A), chain defects or minor amounts of other recurring units might be present, being understood that these latter do not substantially modify the properties of the (PPSU) polymer.

The (PPSU) polymer may be notably a homopolymer or a copolymer such as a random copolymer or a block copolymer. When the (PPSU) polymer is a copolymer, its recurring units are advantageously a mix of recurring units (R_{PPSU}) of formula (K-A) and of recurring units (R_{PPSU}*), different from recurring units (R_{PPSU}), such as recurring units of formula (K-B), (K-C) or (K-D) here below:

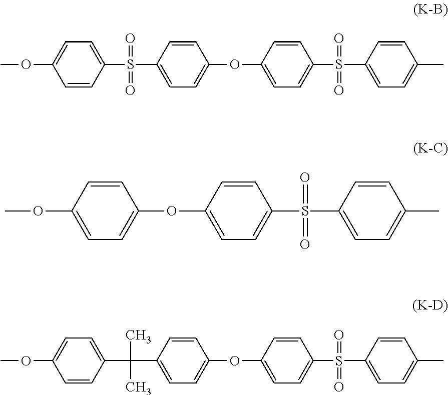

and mixtures thereof.

The (PPSU) polymer can also be a blend of the previously cited homopolymer and copolymer.

Non limitative examples of (PPSU) homopolymers suitable for the invention include those commercially available under the trademark names RADEL® R PPSU and DURADEX® D-3000 PPSU from Solvay Specialty Polymers USA L.L.C.

The (PPSU) polymer can be prepared by known methods. Methods well known in the art are those described in U.S. Pat. No. 3,634,355 (IMPERIAL CHEMICAL INDUSTRIES LIMITED) 11.02.1972 , U.S. Pat. No. 4,008,203 (IMPERIAL CHEMICAL INDUSTRIES LIMITED) 15.02.1977 , U.S. Pat. No. 4,108,837 (UNION CARBIDE CORPORATION) 22.08.1978 and U.S. Pat. No. 4,175,175 (UNION CARBIDE CORPORATION) 20.11.1979, the whole contents of which is herein incorporated by reference.

The Applicant has surprisingly found that, by combining the (PAEK) polymer and the (PPSU) polymer as defined above, it is possible to take advantage of an unexpected synergistic effect which enables obtaining a long term durable solid-wall pipe liner which can be successfully used in the process of the invention for lining metal pipelines commonly conveying oils and gases.

The thermoplastic polymer composition of the process of the invention preferably comprises from 50% to 99% by weight, more preferably from 60% to 90% by weight, based on the total weight of the (PAEK) polymer and the (PPSU) polymer, of at least one (PAEK) polymer as defined above.

The thermoplastic polymer composition of the process of the invention preferably comprises from 1% to 50% by weight, more preferably from 5% to 45% by weight, even more preferably from 10% to 40% by weight, based on the total weight of the (PAEK) polymer and the (PPSU) polymer, of at least one (PPSU) polymer as defined above.

The thermoplastic polymer composition of the process of the invention may comprise at least one plasticizer in amount advantageously comprised between 0.1% and 30% by weight, preferably between 1% and 20% by weight based on the total weight of the (PAEK) polymer and the (PPSU) polymer.

The plasticizers are incorporated without any difficulty in the thermoplastic polymer composition of the process of the invention and produce compositions whose impact strength, especially at low temperature, is advantageously improved. In other words, plasticizers can be advantageously used in the thermoplastic polymer composition of the process of the invention to improve the low temperature behaviour of final parts made from said compositions, especially when these parts are submitted to extreme operating temperatures.

Non limitative examples of suitable plasticizers include, notably, poly(tetrafluoroethylene) polymer [(PTFE) polymer].

Within the scope of the present invention, it is understood, however, that the (PTFE) polymers may also comprise minor amounts of one or more co-monomers such as hexafluoropropylene, perfluoro(methyl vinyl ether), perfluoro(propyl vinyl ether), perfluoro-(2,2-dimethyl-1,3-dioxole), and the like, provided, however that the latter do not significantly adversely affect the unique properties, such as thermal and chemical stability of the PTFE polymer. Preferably, the amount of such co-monomers does not exceed about 3% by moles and is more preferably less than about 1% by moles; particularly preferred is a co-monomer content of less than 0.5% by moles. Most preferred are PTFE homopolymers.

The (PTFE) polymer preferably has a D50 particle size equal to or below 10 μm and has a melt viscosity (MV) equal to or lower than 1×10⁵ Pa×s at 372° C. measured according to ASTM D-1238-52T standard procedure, modified as notably described in U.S. Pat. No. 4,380,618 (E. I. DU PONT DE NEMOURS AND COMPANY) 19.04.1983, the whole contents of which is herein incorporated by reference.

The D50 particle size of the (PTFE) polymer is advantageously equal to or below 10 μm, preferably equal to or below 8 μm, more preferably equal to or below 6 μm. The D50 particle size value of the (PTFE) polymer is preferably equal to or at least 0.05 μm, more preferably equal to or at least 0.1 μm, even more preferably equal to or at least 0.2 μm, still more preferably equal to or at least 1 μm, most preferably equal to or at least 2 μm, still most preferably equal to or at least 3 μm. The D50 particle size value of the (PTFE) polymer is advantageously from 2 μm to 8 μm, preferably from 3 μm to 6 μm.

For the purpose of the present invention, the D50 value of the particle size means a particle size such that 50 weight percent of the relevant material have a larger particle size and 50 weight percent have a smaller particle size.

The D50 value of the particle size of the (PTFE) polymer is measured via light scattering techniques (dynamic or laser) using the techniques provided by Malvern Instruments Inc. or using screen analysis according to DIN 53196.

The (PTFE) polymer of the present invention has advantageously a melt viscosity (MV) of from 50 to 1×10⁵ Pa×s at 372° C. measured according to ASTM D-1238-52T standard procedure, modified as notably described in U.S. Pat. No. 4,380,618 (E. I. DU PONT DE NEMOURS AND COMPANY) 19.04.1983 , the whole contents of which is herein incorporated by reference. The MV of the (PTFE) polymer is preferably of from 100 to 1×10⁴ Pa×s at 372° C. measured according to ASTM D-1238-52T standard procedure, modified as notably described in U.S. Pat. No. 4,380,618 (E. I. DU PONT DE NEMOURS AND COMPANY) 19.04.1983, the whole contents of which is herein incorporated by reference.

The (PTFE) polymer of the present invention has typically a melt flow rate (MFR) of from about 0.10 g/10 min to about 200 g/10 min at 372° C. and under a load of 10 kg, as measured in accordance with ASTM D1238 standard procedure.

In a specific embodiment of the present invention, the melt flow rate (MFR) of the (PTFE) polymer is measured at 325° C. and under a load of 225 g, as measured in accordance with ASTM D1238 standard procedure, and the MFR in general can vary from about 0.10 g/10 min to about 200 g/10 min.

For the purpose of the present invention, it is the second melting temperature of said (PTFE) polymer which can be measured according to a modified ASTM D 3418 method, as specified below. It is understood that the melting point recorded at the second heating period is hereby referred to as the melting point of the (PTFE) polymer of the present invention (Tₘₗₗ).

The (PTFE) polymer of the present invention has advantageously a melting temperature (Tₘₗₗ) equal to or below 330° C.

The (PTFE) polymer is preferably a low molecular weight polymer, that is to say a polymer having a number averaged molecular weight (Mn) advantageously equal to or below 700 000, preferably equal to or below 200 000, preferably equal to or below 100 000, preferably equal to or below 90 000, more preferably equal to or below 50 000, more preferably equal to or below 20 000.

The (PTFE) polymer of the present invention can be synthesized according to any standard chemical methods for the polymerization of tetrafluoroethylene as described in the literature, such as notably by W. H. Tuminello et al., Macromolecules, Vol. 21, pp. 2606-2610 (1988); notably in Kirk-Othmer, The Encyclopaedia of Chemical Technology, 4 th Ed., pub. by John Wiley and Sons (1994) on pp 637-639 of Vol. 11, in US 2011/0218311 (PAUL SMITH ET AL.) 08.09.2011 and as practiced in the art. These publications notably describe the low molecular weight PTFE polymers as being obtained by polymerization or by controlled degradation of common, high molecular weight PTFE homopolymers or low co-monomer content copolymers thereof, for example by controlled thermal decomposition, electron beam, gamma- or other radiation, and the like. Said low molecular weight PTFE polymers are often described in the art as PTFE micropowders.

The thermoplastic polymer composition of the process of the invention may further optionally comprise at least one poly(arylene sulfide) polymer [(PAS) polymer].

For the purpose of the present invention, the term “poly(arylene sulfide) polymer [(PAS) polymer]” is intended to denote any polymer comprising recurring units wherein more than 50% by moles of said recurring units are recurring units (R_{PAS}) of formula:

—(Ar—S)—

wherein Ar denotes an aromatic moiety comprising at least one aromatic mono- or poly-nuclear cycle, such as a phenylene or a naphthylene group, which is linked by each of its two ends to two sulfur atoms forming sulfide groups via a direct C—S linkage.

In recurring units (R_{PAS}), the aromatic moiety Ar may be substituted by one or more substituent groups, including but not limited to halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and substituted or unsubstituted arylene sulfide groups, the arylene groups of which are also linked by each of their two ends to two sulfur atoms forming sulfide groups via a direct C—S linkage thereby creating branched or cross-linked polymer chains.

The (PAS) polymer preferably comprises more than 70% by moles, more preferably more than 80% by moles, still more preferably more than 90% by moles of recurring units (R_{PAS}).

Most preferably, the (PAS) polymer contains no recurring units other than recurring units (R_{PAS}).

In recurring units (R_{PAS}), the aromatic moiety Ar is preferably selected from the group consisting of those of formulae (X-A) to (X-K) here below:

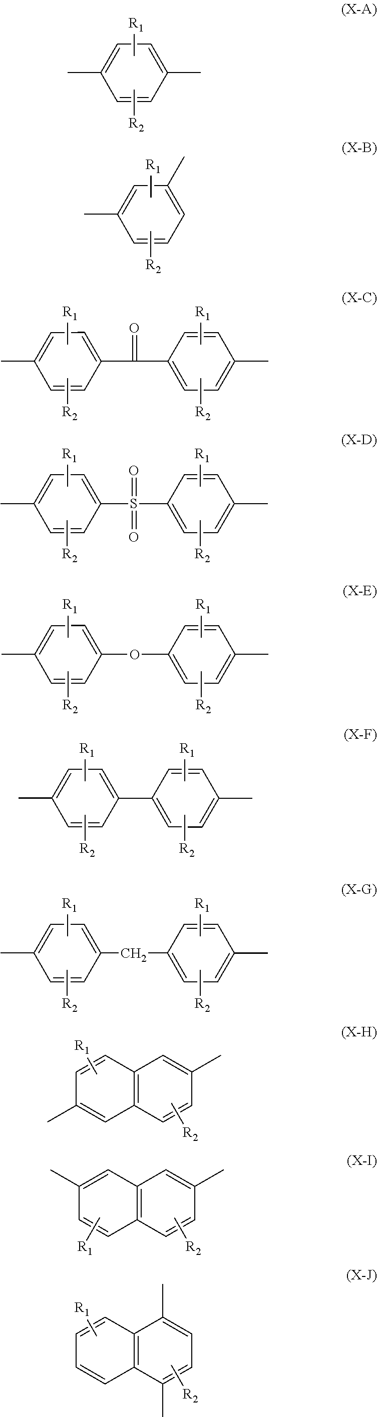

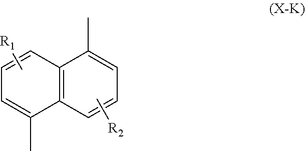

wherein R₁ and R₂, equal to or different from each other, are selected from the group consisting of hydrogen atoms, halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and substituted or unsubstituted arylene sulfide groups, the arylene groups of which are also linked by each of their two ends to two sulfur atoms forming sulfide groups via a direct C—S linkage thereby creating branched or cross-linked polymer chains.

The (PAS) polymer may be a homopolymer or a copolymer such as a random copolymer or a block copolymer.

The (PAS) polymer typically comprises one or more branched or cross-linked recurring units selected from the group consisting of those of formulae (X-L) to (X-N) here below:

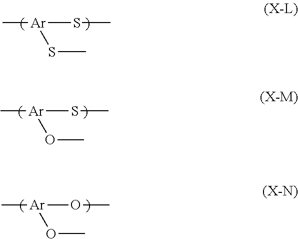

The (PAS) polymer is preferably a poly(phenylene sulfide) polymer [(PPS) polymer]. For the purpose of the present invention, the term “poly(phenylene sulfide) polymer [(PPS) polymer]” is intended to denote any polymer comprising recurring units wherein more than 50% by moles of said recurring units are p-phenylene sulfide recurring units (R_{PPS}) of formula:

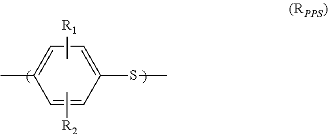

wherein the p-phenylene group is linked by each of its two ends to two sulfur atoms forming sulfide groups via a direct C—S linkage, wherein R₁ and R₂, equal to or different from each other, are selected from the group consisting of hydrogen atoms, halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and substituted or unsubstituted arylene sulfide groups, the arylene groups of which are also linked by each of their two ends to two sulfur atoms forming sulfide groups via a direct C—S linkage thereby creating branched or cross-linked polymer chains.

Non limitative examples of (PPS) polymers suitable for the invention include those commercially available under the trademark names PRIMEF® from Solvay Specialty Polymers USA L.L.C., RYTON® from Chevron Phillips Chemical Company L.L.C., FORTRON® from Fortron Industries and SUPEC® from GE Plastics.

The thermoplastic polymer composition of the process of the invention preferably comprises from 10% to 50% by weight, preferably from 20% to 45% by weight, based on the total weight of the thermoplastic polymer composition, of at least one (PAS) polymer as defined above.

The thermoplastic polymer composition of the process of the invention is typically prepared by any of the usual techniques.

The thermoplastic polymer composition may be prepared by a variety of methods involving intimate admixing of the polymer materials with any optional ingredient, as detailed above, desired in the formulation, for example by melt mixing or a combination of dry blending and melt mixing. Typically, the dry blending of the (PAEK) polymer, the (PPSU) polymer, optionally, a (PAS) polymer and, optionally, a plasticizer and any other optional ingredients is carried out by using high intensity mixers, such as notably Henschel-type mixers and ribbon mixers.

It is also possible to manufacture the thermoplastic polymer composition of the invention by further melt compounding the powder mixture as described above. Conventional melt compounding devices, such as co-rotating and counter-rotating extruders, single screw extruders, co-kneaders, disc-pack processors and various other types of extrusion equipments can be used. Preferably, extruders, more preferably twin screw extruders can be used.

If desired, the design of the compounding screw, e.g. flight pitch and width, clearance, length as well as operating conditions will be advantageously chosen so that sufficient heat and mechanical energy is provided to advantageously fully melt the powder mixture or the ingredients as above detailed and advantageously obtain a homogeneous distribution of the different ingredients.

The thermoplastic polymer composition of the process of the invention preferably comprises, more preferably consists of:
from 50% to 99% by weight, more preferably from 60% to 90% by weight, based on the total weight of the (PAEK) polymer and the (PPSU) polymer, of at least one (PAEK) polymer,
from 1% to 50% by weight, more preferably from 5% to 45% by weight, even more preferably from 10% to 40% by weight, based on the total weight of the (PAEK) polymer and the (PPSU) polymer, of at least one (PPSU) polymer,
optionally, from 10% to 50% by weight, preferably from 20% to 45% by weight, based on the total weight of the thermoplastic polymer composition, of at least one (PAS) polymer, and
optionally, from 0.1% to 30% by weight, preferably from 1% to 20% by weight, based on the total weight of the (PAEK) polymer and the (PPSU) polymer, of at least one plasticizer.

Very good results have been obtained with a thermoplastic polymer composition comprising, more preferably consisting of:
from 60% to 90% by weight, based on the total weight of the (PAEK) polymer and the (PPSU) polymer, of at least one (PAEK) polymer,
from 10% to 40% by weight, based on the total weight of the (PAEK) polymer and the (PPSU) polymer, of at least one (PPSU) polymer,
optionally, from 10% to 50% by weight, based on the total weight of the thermoplastic polymer composition, of at least one (PAS) polymer, and
optionally, from 1% to 20% by weight, based on the total weight of the (PAEK) polymer and the (PPSU) polymer, of at least one plasticizer.

In step (i) of the process of the invention, the thermoplastic polymer composition is typically processed by extrusion, injection moulding, sheathing and the like.

In step (ii) of the process of the invention, the pipe liner is typically deformed by reducing its cross-sectional area.

Techniques for reducing the cross-sectional area of a pipe liner to enable it to be installed in a pipeline are well known in the art.

In step (ii) of the process of the invention, the pipe liner is preferably deformed by reducing its cross-sectional area by means of radial or axial compression.

According to one type of technique, the so-called Roll Down process, the cross-sectional area of the pipe liner is reduced by means of radial compression typically using sets of compression rollers.

According to another type of technique, the cross-sectional area of the pipe liner is reduced by means of axial compression typically pulling the pipe liner through a diameter reducing die. The diameter reduction is only achieved so long as the axial tension on the pipe liner is maintained. Non-limitative examples of this type of process are the techniques known as Swagelining, Die-drawing and Titeliner.

In step (iii) of the process of the invention, the deformed pipe liner is expanded to fit with the inner diameter of the pipeline typically by elastic recovery. The deformed pipe liner may be also expanded by heat and/or pressurisation with oils and gases.

The process of the invention advantageously ensures that the pipe liner is fitted in firm contact with the metal pipeline.

The Applicant has found that the thermoplastic polymer composition of the process of the invention advantageously enables obtaining pipe liners which successfully exhibit elastic recovery rate values suitable for lining metal pipelines commonly conveying oils and gas, the pipe liners so obtained being also resistant to heat and pressure and to harsh chemical environment.

Another object of the present invention is a pipeline system comprising at least two coaxial pipes:
an outer metal pipeline, and
an inner pipe comprising at least one layer comprising, preferably made of, a thermoplastic polymer composition comprising:
at least one poly(aryl ether ketone) polymer [(PAEK) polymer],
at least one poly(phenylene sulfone) polymer [(PPSU) polymer],
optionally, at least one poly(arylene sulfide) [(PAS) polymer], and
optionally, at least one plasticizer.

The (PAEK) polymer, the (PPSU) polymer, the (PAS) polymer and the plasticizer of the thermoplastic polymer composition of the pipeline system of the invention are defined as above.

The Applicant has found that the inner pipe of the pipeline system of the invention successfully enables protecting from corrosion metal pipelines commonly conveying hydrocarbons at temperatures of up to 130° C. or more, such as on-shore and off-shore oil and gas metal pipes.

The pipeline system preferably comprises two coaxial pipes, wherein the outer diameter of the inner pipe fits with the inner diameter of the metal pipeline.

The pipeline system more preferably consists of two coaxial pipes, wherein the outer diameter of the inner pipe fits with the inner diameter of the metal pipeline.

The metal pipeline is usually an iron or steel pipe, preferably a steel pipe, more preferably a carbon, alloy or stainless steel pipe.

The pipeline system of the invention more preferably consists of two coaxial pipes:
an outer steel pipe, and
an inner pipe comprising at least one layer comprising, preferably made of, a thermoplastic polymer composition, preferably consisting of:
from 50% to 99% by weight, more preferably from 60% to 90% by weight, based on the total weight of the (PAEK) polymer and the (PPSU) polymer, of at least one (PAEK) polymer,
from 1% to 50% by weight, more preferably from 5% to 45% by weight, even more preferably from 10% to 40% by weight, based on the total weight of the (PAEK) polymer and the (PPSU) polymer, of at least one (PPSU) polymer,
optionally, from 10% to 50% by weight, preferably from 20% to 45% by weight, based on the total weight of the thermoplastic polymer composition, of at least one (PAS) polymer, and
optionally, from 0.1% to 30% by weight, preferably from 1% to 20% by weight, based on the total weight of the (PAEK) polymer and the (PPSU) polymer, of at least one plasticizer,
   wherein the outer diameter of the inner pipe fits with the inner diameter of the steel pipe.

The thermoplastic polymer composition of the pipeline system of the invention preferably comprises, more preferably consists of:
from 60% to 90% by weight, based on the total weight of the (PAEK) polymer and the (PPSU) polymer, of at least one (PAEK) polymer,
from 10% to 40% by weight, based on the total weight of the (PAEK) polymer and the (PPSU) polymer, of at least one (PPSU) polymer,
optionally, from 10% to 50% by weight, based on the total weight of the thermoplastic polymer composition, of at least one (PAS) polymer, and
optionally, from 1% to 20% by weight, based on the total weight of the (PAEK) polymer and the (PPSU) polymer, of at least one plasticizer.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

Raw Materials

KETASPIRE® KT-820 NT PEEK having a melt flow rate of 8.5 g/10 min (ASTM D1238, 400° C., 2.16 Kg).

RADEL® R-5900 NT PPSU having a melt flow rate of 30.0 g/10 min (ASTM D1238, 400° C., 2.16 Kg).

Determination of Mechanical Properties

The flexural modulus of the pipe liner has been measured using ISO 178 standard procedure.

The elongation at yield of the pipe liner has been measured using ASTM D638 standard procedure.

Determination of Thermal Properties

The heat deflection temperature (HDT) of the pipe liner has been measured using ASTM D648 standard procedure under a load of 264 psi.

### EXAMPLE 1

A pipe liner was extruded according to known procedures from a thermoplastic polymer composition prepared by melt compounding the following components:
75% by weight of KETASPIRE® KT-820 NT PEEK, and
25% by weight of RADEL® R-5900 NT PPSU.

### COMPARATIVE EXAMPLE 1

A pipe liner was extruded according to known procedures from a thermoplastic polymer composition made of KETASPIRE® KT-820 NT PEEK.

It has been demonstrated that pipe liners obtained by processing thermoplastic polymer compositions according to the process of the invention are endowed with mechanical properties which enable them to be advantageously used in the process of the invention.

As shown in Table 1 here below, the pipe liners obtained by processing the thermoplastic polymer composition according to Example 1 of the invention are advantageously endowed with lower flexural modulus and higher elongation at yield values as compared with the pipe liners obtained by processing the thermoplastic polymer composition according to comparative Example 1 such that the pipe liners so obtained advantageously undergo a higher flexibility and thus temporary elastic deformation during insertion of the deformed pipe liner in the metal pipeline.

Also, as shown in Table 1 here below, the pipe liners obtained by processing the thermoplastic polymer composition according to Example 1 of the invention are advantageously endowed with higher heat deflection temperature (HDT) as compared with the pipe liners obtained by processing the thermoplastic polymer composition according to comparative Example 1 such that the pipe liners so obtained advantageously undergo a higher thermo-mechanical stability during operation of the metal pipeline in downhole applications and thus reducing risks of collapse of the pipe liners during installation and decompression cycles.

TABLE 1

| | Flexural | Tensile elonga- | HDT |
|---|---|---|---|
| | modulus | tion at yield | [264 psi, |
| Run | [GPa] | [%] | ° C.] |
| Example 1 | 3.3 | 6.0 | 181 |
| C. Example 1 | 3.7 | 5.2 | 157 |

In view of the above, it has been found that the pipe liners made of the composition of the process of the invention are endowed with mechanical properties and chemical resistance properties that make them suitable for successfully lining metal pipelines.

1-14. (canceled)

15. A process for lining a metal pipeline, said process comprising the following steps:
(i) processing a thermoplastic polymer composition thereby providing a pipe liner having an outer diameter greater than the inner diameter of said metal pipeline, said thermoplastic polymer composition comprising:
at least one poly(aryl ether ketone) polymer, (PAEK) polymer,
at least one poly(phenylene sulfone) polymer, (PPSU) polymer,
optionally, at least one poly(arylene sulfide), (PAS) polymer, and
optionally, at least one plasticizer;
(ii) deforming said pipe liner thereby providing a deformed pipe liner having an outer diameter smaller than the inner diameter of said metal pipeline;
(iii) inserting the deformed pipe liner in said metal pipeline; and
(iv) expanding the deformed pipe liner to fit with the inner diameter of said metal pipeline.

16. The process according to claim 15, wherein the (PAEK) polymer comprises recurring units wherein more than 50% by moles of said recurring units are recurring units (R_{PAEK}) selected from the group consisting of those of formulae (J-A) to (J-O) here below: 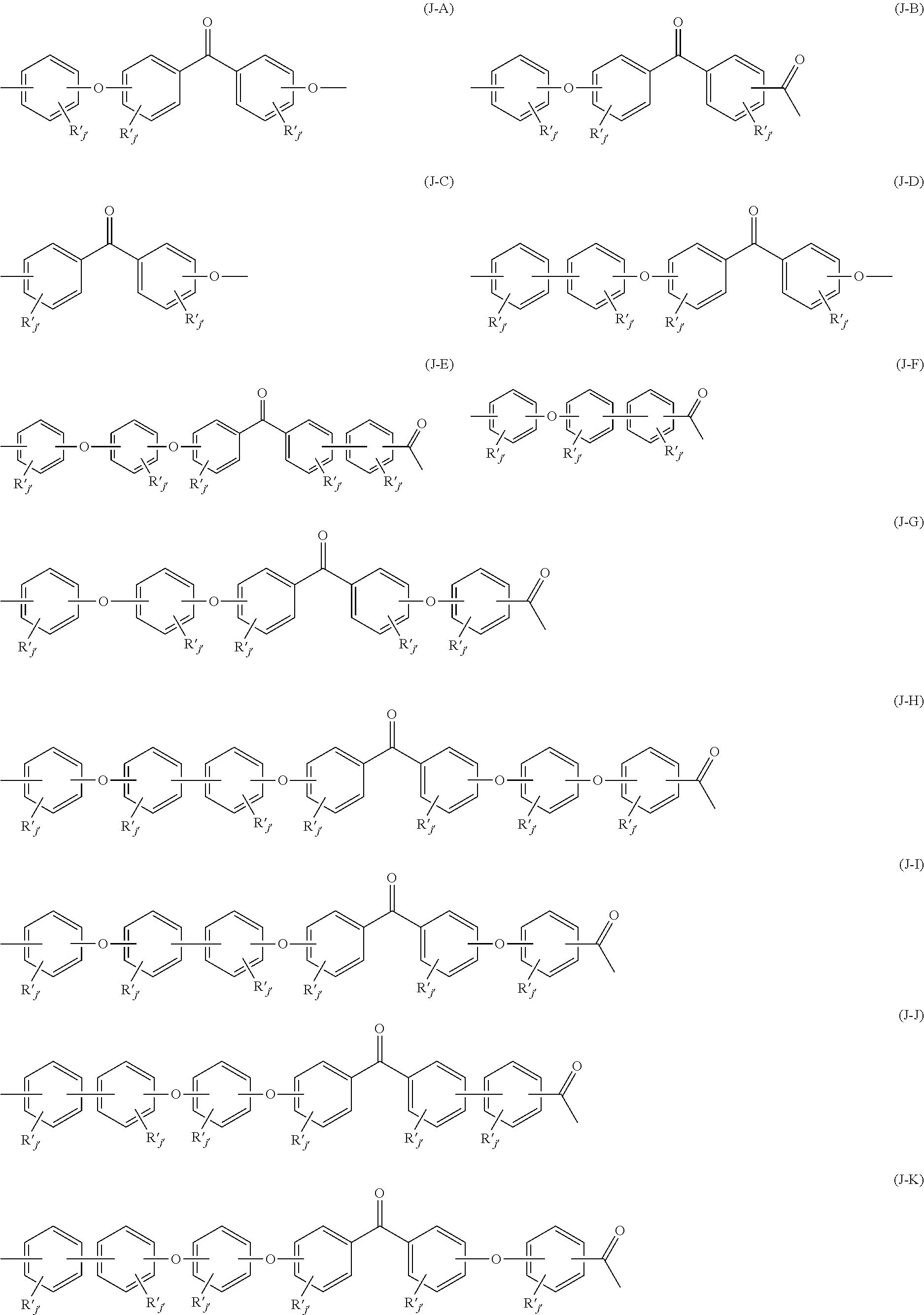 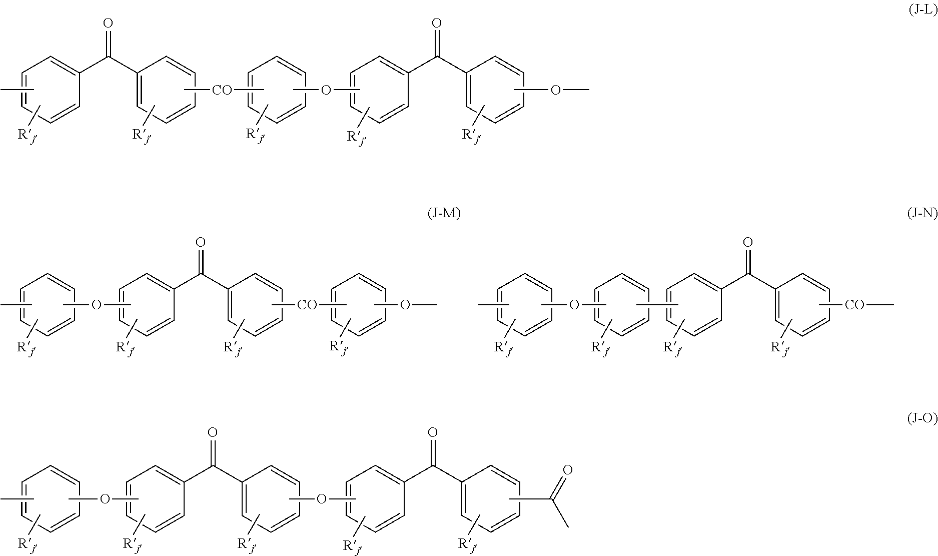
wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
-j′ is zero or an integer from 1 to 4.

17. The process according to claim 15, wherein the thermoplastic polymer composition comprises from 50% to 99% by weight, based on the total weight of the (PAEK) polymer and the (PPSU) polymer, of at least one (PAEK) polymer.

18. The process according to claim 15, wherein the (PPSU) polymer comprises recurring units wherein more than 50% by moles of said recurring units are recurring units (R_{PPSU}) of formula (K-A):

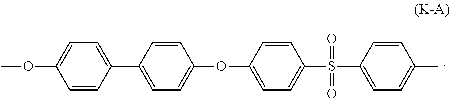

19. The process according to claim 15, wherein the thermoplastic polymer composition comprises from 1% to 50% by weight, based on the total weight of the (PAEK) polymer and the (PPSU) polymer, of at least one (PPSU) polymer.

20. The process according to claim 15, wherein the (PAS) polymer comprises recurring units wherein more than 50% by moles of said recurring units are recurring units (R_{PAS}) of formula:
—(Ar—S)—
wherein Ar denotes an aromatic moiety comprising at least one aromatic mono- or poly-nuclear cycle, which is linked by each of its two ends to two sulfur atoms forming sulfide groups via a direct C—S linkage.

21. The process according to claim 15, wherein the (PAS) polymer is a poly(phenylene sulfide) polymer, (PPS) polymer, comprising recurring units wherein more than 50% by moles of said recurring units are p-phenylene sulfide recurring units (R_{PPS}) of formula: 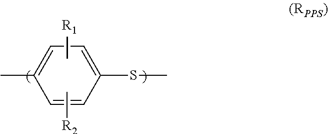
wherein the p-phenylene group is linked by each of its two ends to two sulfur atoms forming sulfide groups via a direct C—S linkage, wherein R₁ and R₂, equal to or different from each other, are selected from the group consisting of hydrogen atoms, halogen atoms, C₁-C₁₂ alkyl groups, C₇-C₂₄ alkylaryl groups, C₇-C₂₄ aralkyl groups, C₆-C₂₄ arylene groups, C₁-C₁₂ alkoxy groups, and C₆-C₁₈ aryloxy groups, and substituted or unsubstituted arylene sulfide groups, the arylene groups of which are also linked by each of their two ends to two sulfur atoms forming sulfide groups via a direct C—S linkage thereby creating branched or cross-linked polymer chains.

22. The process according to claim 15, wherein the thermoplastic polymer composition comprises from 10% to 50% by weight, based on the total weight of the thermoplastic polymer composition, of at least one (PAS) polymer.

23. The process according to claim 15, wherein the thermoplastic polymer composition comprises at least one plasticizer in amount comprised between 0.1% and 30% by weight, based on the total weight of the (PAEK) polymer and the (PPSU) polymer.

24. The process according to claim 15, wherein the thermoplastic polymer composition comprises, more preferably consists of:
from 60% to 90% by weight, based on the total weight of the (PAEK) polymer and the (PPSU) polymer, of at least one (PAEK) polymer,
from 10% to 40% by weight, based on the total weight of the (PAEK) polymer and the (PPSU) polymer, of at least one (PPSU) polymer,
optionally, from 10% to 50% by weight, based on the total weight of the thermoplastic polymer composition, of at least one (PAS) polymer, and
optionally, from 1% to 20% by weight, based on the total weight of the (PAEK) polymer and the (PPSU) polymer, of at least one plasticizer.

25. The process according to claim 15, wherein the pipe liner is deformed by reducing its cross-sectional area by means of radial or axial compression.

26. A pipeline system comprising at least two coaxial pipes:
an outer metal pipeline, and
an inner pipe comprising at least one layer comprising a thermoplastic polymer composition comprising:
at least one poly(aryl ether ketone) polymer, (PAEK) polymer,
at least one poly(phenylene sulfone) polymer, (PPSU) polymer,
optionally, at least one poly(arylene sulfide), (PAS) polymer, and
optionally, at least one plasticizer.

27. The pipeline system according to claim 26, wherein the outer diameter of the inner pipe fits with the inner diameter of the metal pipeline.

28. The pipeline system according to claim 26, wherein the thermoplastic polymer composition comprises:
from 60% to 90% by weight, based on the total weight of the (PAEK) polymer and the (PPSU) polymer, of at least one (PAEK) polymer,
from 10% to 40% by weight, based on the total weight of the (PAEK) polymer and the (PPSU) polymer, of at least one (PPSU) polymer,
optionally, from 10% to 50% by weight, based on the total weight of the thermoplastic polymer composition, of at least one (PAS) polymer, and
optionally, from 1% to 20% by weight, based on the total weight of the (PAEK) polymer and the (PPSU) polymer, of at least one plasticizer.

29. The process according to claim 15, wherein the thermoplastic polymer composition comprises from 60% to 90% by weight, based on the total weight of the (PAEK) polymer and the (PPSU) polymer, of at least one (PAEK) polymer.

30. The process according to claim 15, wherein the thermoplastic polymer composition comprises from 5% to 45% by weight, based on the total weight of the (PAEK) polymer and the (PPSU) polymer, of at least one (PPSU) polymer.

31. The process according to claim 15, wherein the thermoplastic polymer composition comprises from 10% to 40% by weight, based on the total weight of the (PAEK) polymer and the (PPSU) polymer, of at least one (PPSU) polymer.

32. The process according to claim 20, wherein the aromatic mono- or poly-nuclear cycle is a phenylene or a naphthylene group.

33. The process according to claim 15, wherein the thermoplastic polymer composition comprising from 20% to 45% by weight, based on the total weight of the thermoplastic polymer composition, of at least one (PAS) polymer.

34. The process according to claim 15, wherein the thermoplastic polymer composition comprises at least one plasticizer in amount comprised between 1% and 20% by weight, based on the total weight of the (PAEK) polymer and the (PPSU) polymer.
